(19) United States
(12) Patent Application Publication
(10) Pub. No.: US 2008/0085934 A1
(43) Pub. Date: Apr. 10, 2008

(54) Bisdithiocarbamate fungicide stabilization

(75) Inventors: Norman R. Pearson, Carmel, IN (US); Daniel L. Dermody, Midland, MI (US); Melissa A. Mushrush, Midland, MI (US); Christopher J. Tucker, Midland, MI (US)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 11/906,857

(22) Filed: Oct. 4, 2007

Related U.S. Application Data
(60) Provisional application No. 60/849,408, filed on Oct. 4, 2006.

(51) Int. Cl. A01N 37/44; A01P 3/00

(52) U.S. Cl. 514/561

(57) ABSTRACT

A composition comprising at least one bisdithiocarbamate fungicide and at least one zinc additive is provided. Processes related thereto are also provided.

### CROSS-REFERENCE TO RELATED APPLICATIONS

This application claims the benefit of U.S. Provisional Application No. 60/849,408, filed on Oct. 4, 2006, the disclosure of which is expressly incorporated by reference herein.

### BACKGROUND OF THE INVENTION

The field of this invention is related to bisdithiocarbamate fungicide stabilization and processes associated therewith.

It is generally known that bisdithiocarbamates are unstable compounds that readily breakdown during manufacture, storage, or shipping. Currently, the main stabilizer used is hexamethylenetetramine (CAS#100-97-0) (HMT). However, research is on-going in search of better stabilizers for bisdithiocarbamates.

### SUMMARY OF THE INVENTION

A composition comprising at least one bisdithiocarbamate fungicide and at least one zinc additive is provided. Processes related thereto are also provided.

### DETAILED DESCRIPTION OF THE INVENTION

Bisdithiocarbamates are known as multi-site fungicides. Several examples exist and are commercially used to protect plants from fungi. Suitable examples are:

ferbam (CAS#14484-64-1);

mancopper (CAS#53988-93-5);

mancozeb (CAS#8018-01-7);

maneb (CAS#1247-38-2);

metiram (CAS#9006-42-2);

nabam (CAS#142-59-6);

propineb (CAS#12071-83-9);

thiram (CAS#137-26-8);

zineb (CAS#12122-67-7); and

ziram (CAS#137-30-4).

In another embodiment alkylenebisdithiocarbamates work well with the zinc additives disclosed herein. In another embodiment, ethylenebis-dithiocarbamates work well with the zinc additives disclosed herein, because these zinc additives help to prevent the appearance of ethylenethiourea (which is a breakdown product of these ethylenebisdithiocarbamates) during storage, manufacture, or shipping.

The zinc additives are any zinc containing compound that when added to a composition comprising the bisdithiocarbamates, stabilizes the amount of bisdithiocarbamates in such composition, when compared to a control composition that does not contain such zinc additive or may contain a lesser amount of a zinc compound (as for example mancozeb). While not wanting to be bound by theory, it is believed that at least a portion, perhaps a substantial portion, of the zinc additive, during processing, dissociates from the rest of the additive and helps protect the bisdithiocarbamate by forming a protective coating. The following compounds are useful as zinc additives.

| Zinc Additives Table | CAS # |
|---|---|
| Zinc acetate | 557-34-6 |
| Zinc acetylacetonate | 108503-47-5 |
| Zinc ammonium nitrite | 63885-01-8 |
| Zinc bromide | 7699-45-8 |
| Zinc butylxanthate | 150-88-9 |
| Zinc carbonate | 3486-35-9 |
| Zinc citrate | 5990-32-9 |
| Zinc chloride | 7646-85-7 |
| Zinc ethylsulfate | 5970-49-0 |
| Zinc fluorosilicate | 16871-71-9 |
| Zinc formate | 557-41-5 |
| Zinc gluconate | 4468-02-4 |
| Zinc hydrosulfite | 7779-86-4 |
| Zinc hydroxide | 20427-58-1 |
| Zinc hypophosphite | 15060-64-7 |
| Zinc iodide | 10139-47-6 |
| Zinc lactate D/L forms | 16039-53-5 |
| Zinc malate | 2847-05-4 |
| Zinc molybdate | 13767-32-3 |
| Zinc nitrate | 7779-88-6 |
| Zinc oxalate | 547-68-2 |
| Zinc oxide | 1314-13-2 |
| Zinc phosphate | 7779-90-9 |
| Zinc propionate | 557-28-8 |
| Zinc pyrophosphate | 7446-26-6 |
| Zinc salicylate | 16283-36-6 |
| Zinc silicate | 13597-65-4 |
| Zinc sulfate | 7733-02-0 |
| Zinc sulfite | 7488-52-0 |
| Zinc thiocyanate | 557-42-6 |

The amount of zinc additive to use with these bisdithiocarbamates is given in Table 1.

TABLE 1

| | Approximate Weight Percent | | |
|---|---|---|---|
| | (based on total weight of these components) | | |
| Component | Broad Range | Broader Range | Broadest Range |
| bisdithiocarbamate | about 90-97% | about 85-98% | about 80-99% |
| Zinc additive | about 10-3% | about 15-2% | about 20-1% |

The zinc additive and the bisdithiocarbamates can be mixed together in any conventional manner known in the art. Once mixed together the amount of bisdithiocarbamate in the mixture will be more stable than a control composition not containing any zinc additive. It is also envisioned that these zinc additives can be used with hexamethylenetetramine in order to more fully stabilize the amount of bisdithiocarbamate in the composition. Additionally, this could entail being able to use less hexamethylenetetramine than is usually required in order to obtain the same effect as using hexamethylenetetramine only. In this embodiment, the amount of hexamethylenetetramine and the amount of zinc additive to use can vary in accordance with the total amount of zinc additive given in Table 1.

The stabilized bisdithiocarbamates can be used in any manner that is known in the art as in the practices long used with other bisdithiocarbamates not stabilized in the manner of this invention. In particular these stabilized bisdithiocarbamates can be applied to a locus to protect plants from fungi. While these stabilized bisdithiocarbamates can be applied after fungi have attacked plants of concern, this is not currently the most preferred method of protecting plants. The amount of bisdithiocarbamate to apply is a fungicidally effective amount. In most cases this means an amount sufficient to protect the plants of concern from significant harm. Usually this means applying an amount that kills or inhibits the fungi, but that is not significantly toxic to the plant. The exact amount to use varies with the fungal disease to be controlled, the type of formulation employed, the method of application, the particular plant species, climate conditions, and the like. A suitable application rate is typically in the range from about 0.1 to about 4 pounds/acre (about 0.1 to 0.45 grams per square meter).

### EXAMPLE

This example is provided to further illustrate this invention. It is not meant to limit the scope of the invention.

The sample preparation and stability screening was done on a very small scale (ca. 100 mg of mancozeb) in 96 well microtitre plates using semi-automated, high throughput screening (HTS) methodology that is well known in the art. While this method of sample preparation is not identical to the actual process for manufacturing mancozeb, it serves as a useful method for identifying new compositions that can provide storage stability for mancozeb.

General sample preparation procedure: All sample preparation operations were conducted in an inert atmosphere to minimize oxidative degradation by oxygen. Efficient elimination of oxygen in the sample preparation and analytical portions of this mancozeb stability screen is critical to achieving reproducible results. The following is a typical sample preparation: Maneb (61.5 parts; used as 60 wt % wet cake with the remainder water), dispersant (sodium lignosulfonate; 1 part), zinc sulfate heptahydrate (2.5 parts), and water (35 parts) were combined under nitrogen and mixed for ten minutes using a Siemens Speedmixer (dual-axis) at ˜2200 rpm in 5-minute increments to prevent sample heating. The paste formed was then added (250 μL) under nitrogen to 1-mL vials contained HMT stabilizer in water (5%), such that the final wt % HMT in the mancozeb was 0.9% (dry basis; ca. 100 mg sample size). The zinc level in this sample was 3.4% (dry basis). After thorough mixing to blend the HMT with the paste (3-4 minutes using Vortex mixing and 5-10 minutes on a paint shaker), the samples were dried by freeze-drying them overnight @−40° C. (ca. 60 mm Hg). Alternatively, centrifugal heated drying in a Genevac (70° C. with slight vacuum/N2 overnight) could also be used though it was more cumbersome and the results were less reliable. Both methods do not involve any agitation or mixing of the samples as they were dried. Achieving a final water level of ca. 1% or less in the samples was desired. Typically, 5 replications of each composition were prepared and tested at a time.

Ageing of samples: The dry samples (open to the atmosphere) were then placed in a 50° C. air vented oven for two weeks to simulate accelerated ageing on storage and were than cooled to rt.

Analysis for ETU: The estimate of mancozeb stability is based on the formation of the oxidation by-product ETU (ethylene thiourea) which forms when mancozeb is degraded by exposure to air and moisture. Higher levels of ETU indicate increased degradation of mancozeb. The aged samples were maintained in an inert atmosphere to minimize any further oxidative degradation during analytical processing and were diluted with methanol (1 mL) containing benzophenone standard and mixed thoroughly (˜15 minutes using a combination of a Vortex mixer and a paint shaker) to extract the decomposition product ETU from the solid mancozeb. The extraction solution was separated from the solids via centrifugation (3000 rpm, 20 min) and then transferred by pipette to new vials. These vials were then centrifuged before analysis by gas chromatography (DB-1701 column, isothermal @ 250° C.), in which the ETU signal was integrated with respect to the internal standard (benzophenone). Standard samples of ETU and benzophenone were also analyzed by GC to generate response factors and the linearity of the analysis.

In Table E1, the 2.4% zinc sample contains a similar amount of zinc as does a current commercial product called Dithane® (available from Dow AgroSciences LLC). The other entries show the amount of zinc from mancozeb plus the amount of zinc from the zinc additive. This table clearly shows that adding a zinc additive to the composition greatly lowers the amount of ETU produced which thereby indicates improved stability of the mancozeb (a bisdithiocarbamate).

TABLE E1

| Zinc | ETU formed |
|---|---|
| weight percent | weight percent |
| 2.4 | 0.130 |
| 3.7 | 0.069 |
| 4.9 | 0.084 |
| 6.1 | 0.069 |
| 7.3 | 0.033 |

What is claimed is:

1. A composition comprising:
(a) at least one bisdithiocarbamate; and
(b) at least one zinc additive.

2. A process comprising mixing:
(a) at least one bisdithiocarbamate; and
(b) at least one zinc additive.

3. A process of protecting plants from fungi, said process comprising applying to a locus a fungicidally effective amount of a composition according to claim 1.
